(19) United States
(12) Patent Application Publication
(10) Pub. No.: US 2014/0120249 A1
(43) Pub. Date: May 1, 2014

(54) MAGNETIC RECORDING MEDIUM MANUFACTURING METHOD AND MICROPATTERN MANUFACTURING METHOD

(71) Applicant: KABUSHIKI KAISHA TOSHIBA, Tokyo (JP)

(72) Inventors: Kaori KIMURA, Yokohama-shi (JP); Kazutaka TAKIZAWA, Kawasaki-shi (JP); Akira WATANABE, Kawasaki-shi (JP); Takeshi IWASAKI, Inagi-shi (JP); Akihiko TAKEO, Kokubunji-shi (JP)

(73) Assignee: KABUSHIKI KAISHA TOSHIBA, Tokyo (JP)

(21) Appl. No.: 13/760,832

(22) Filed: Feb. 6, 2013

(30) Foreign Application Priority Data
Oct. 25, 2012 (JP) 2012-235504

(51) Int. Cl. G11B 5/84

(52) U.S. Cl. CPC G11B 5/84
USPC 427/130

(57) ABSTRACT

According to one embodiment, in a magnetic recording medium manufacturing method, an inversion liftoff layer and pattern formation layer are formed on a layer on which an inverted pattern is to be formed, a depressions pattern is formed by patterning the pattern formation layer and transferred to the inversion liftoff layer, the surface of the layer on which an inverted pattern is to be formed is exposed by removing the inversion liftoff layer from depressions, an inversion layer is formed on the inversion liftoff layer and exposed layer, and the inversion liftoff layer is removed, thereby forming, on the exposed layer, an inversion layer having a projections pattern obtained by inverting the depressions pattern.

### CROSS-REFERENCE TO RELATED APPLICATIONS

This application is based upon and claims the benefit of priority from Japanese Patent Application No. 2012-235504, filed Oct. 25, 2012, the entire contents of which are incorporated herein by reference.

### FIELD

Embodiments described herein relate generally to a magnetic recording medium manufacturing method and micropattern manufacturing method.

### BACKGROUND

Micropatterns on surfaces are processed into three-dimensional structures in the technical fields of, e.g., hard disk media, antireflection films, catalysts, microchips, and optical devices.

As the recording densities of magnetic recording apparatuses increase, magnetic recording media having three-dimensional structures such as patterned media and BPM (Bit Patterned Media) have been proposed for achieving high recording densities. A patterned medium can be obtained by processing the surface of a recording layer of a hard disk medium into a three-dimensional microstructure. It is important to form a three-dimensional pattern on the patterned medium. When using a self-organizing process to form a periodical three-dimensional structure, a dot-like projections pattern is necessary in a recording portion. However, a master pattern formed by self-organization is not necessarily a dot-like projections pattern, and is sometimes a dot-like depressions pattern. For example, when using mesoporous silica as a master pattern, the central portions of micelles of mesoporous silica arranged into a single layer are initially occupied by an organic compound, but the organic compound is burnt down while silica is baked. In this case, a necessary dot portion is lost, so the pattern does not function as a mask. This makes it necessary to invert the three-dimensional shape in a later process. To invert the three-dimensional shape, it is necessary to selectively remove projecting portions around the dot-like depressions pattern. However, if the projecting portions are made of a material such as a metal, they cannot easily be removed with a solvent or the like.

This difficulty in inverting the three-dimensional shape similarly applies to a microchip, optical device, and the like.

### BRIEF DESCRIPTION OF THE DRAWINGS

FIG. 1 is a view showing an example of a depressions pattern formed by a self-organizing material;

FIG. 2 is a front view showing examples of bit patterned medium three-dimensional patterns obtained by EB lithography;

FIG. 3 is a partially exploded perspective view showing an example of a magnetic recording/reproduction apparatus to which a magnetic recording medium according to an embodiment is applicable;

FIGS. 4A, 4B, 4C, 4D, 4E, 4F, 4G, 4H, and 4I are views showing an example of the manufacturing steps of a medium according to the fourth embodiment;

FIGS. 5A, 5B, 5C, 5D, 5E, 5F, 5G, and 5H are views showing another example of the manufacturing steps of the medium according to the fourth embodiment;

FIGS. 6A, 6B, 6C, 6D, 6E, 6F, 6G, and 6H are views showing an example of the manufacturing steps of a medium according to the third embodiment;

FIGS. 7A, 7B, 7C, 7D, 7E, 7F, 7G, and 7H are views showing still another example of the manufacturing steps of the medium according to the fourth embodiment;

FIGS. 8A, 8B, 8C, 8D, 8E, and 8F are views showing an example of the manufacturing steps of a medium according to the first embodiment;

FIGS. 9A, 9B, 9C, 9D, 9E, 9F, 9G, and 9H are views showing an example of the manufacturing steps of a medium according to the second embodiment; and

FIGS. 10A, 10B, 10C, 10D, 10E, 10F, 10G, and 10H are views showing another example of the manufacturing steps of the medium according to the third embodiment.

### DETAILED DESCRIPTION

In general, according to one embodiment, a magnetic recording medium manufacturing method according to the first embodiment includes the steps of

(1) forming a magnetic recording layer on a substrate,

(2) forming an inversion liftoff layer on the magnetic recording layer,

(3) forming a pattern formation layer on the inversion liftoff layer,

(4) forming a depressions pattern by patterning the pattern formation layer,

(5) transferring the depressions pattern to the inversion liftoff layer and removing the inversion liftoff layer from depressions, thereby exposing the surface of the layer formed below the inversion liftoff layer,

(6) forming an inversion layer on the inversion liftoff layer and exposed layer and removing the inversion liftoff layer, thereby forming, on the exposed layer, an inversion layer having a projections pattern obtained by inverting the depressions pattern, and

(7) transferring the projections pattern to the magnetic recording layer.

Examples of the layer formed directly below the inversion liftoff layer and exposed are the magnetic recording layer, and a protective layer formed between the magnetic recording layer and inversion liftoff layer.

A magnetic recording medium manufacturing method according to the second embodiment includes the steps of

(1) forming a magnetic recording layer on a substrate,

(2-1A) forming a mask layer on the magnetic recording layer,

(2-2A) forming an inversion liftoff layer on the mask layer,

(3) forming a pattern formation layer on the inversion liftoff layer,

(4) forming a depressions pattern by patterning the pattern formation layer,

(5-1A) transferring the depressions pattern to the inversion liftoff layer, thereby exposing the surface of the mask layer to depressions,

(6-1A) forming an inversion layer on the inversion liftoff layer and the exposed surface of the mask layer, and removing the inversion liftoff layer, thereby forming, on the surface of the mask layer, an inversion layer having a projections pattern obtained by inverting the depressions pattern,

(7-1A) transferring the projections pattern to the mask layer, and

(7-2A) transferring the projections pattern to the magnetic recording layer.

The magnetic recording medium manufacturing method according to the second embodiment is an example of the magnetic recording medium manufacturing method according to the first embodiment, and includes the step of forming the mask layer between the magnetic recording layer and inversion liftoff layer.

The layer formed directly below the inversion liftoff layer and exposed is the mask layer.

The projections pattern can be transferred to the mask layer before being transferred to the magnetic recording layer.

A magnetic recording medium manufacturing method according to the third embodiment includes the steps of

(1) forming a magnetic recording layer on a substrate,

(2-1B) forming a liftoff layer on the magnetic recording layer,

(2-2B) forming a mask layer on the liftoff layer,

(2-3B) forming an inversion liftoff layer on the mask layer,

(3-1B) forming a pattern formation layer on the inversion liftoff layer,

(4) forming a depressions pattern by patterning the pattern formation layer,

(5-1B) transferring the depressions pattern to the inversion liftoff layer, thereby exposing the surface of the mask layer to depressions,

(6-1B) forming an inversion layer on the inversion liftoff layer and the exposed surface of the mask layer, and removing the inversion liftoff layer, thereby forming, on the surface of the mask layer, an inversion layer having a projections pattern obtained by inverting the depressions pattern,

(7-1B) transferring the projections pattern to the mask layer,

(7-2B) transferring the projections pattern to the liftoff layer and magnetic recording layer, and

(7-3B) removing the liftoff layer.

The magnetic recording medium manufacturing method according to the third embodiment is an example of the magnetic recording medium manufacturing method according to the first embodiment, and includes the steps of sequentially forming the liftoff layer, mask layer, and inversion liftoff layer on the magnetic recording layer.

The layer formed directly below the inversion liftoff layer and exposed is the mask layer.

The projections pattern can be transferred to the mask layer before being transferred to the magnetic recording layer.

The projections pattern can be transferred to the liftoff layer and magnetic recording layer at once.

The mask layer can be removed by removing the liftoff layer.

A magnetic recording medium manufacturing method according to the fourth embodiment includes the steps of

(1) forming a magnetic recording layer on a substrate,

(2-1C) forming a liftoff layer on the magnetic recording layer,

(2-2C) forming a mask layer on the liftoff layer,

(2-3C) forming an inversion liftoff layer on the mask layer,

(2-4C) forming a sub mask layer on the inversion liftoff layer,

(3-1C) forming a pattern formation layer on the inversion liftoff layer,

(4) forming a depressions pattern by patterning the pattern formation layer,

(5-1C) transferring the depressions pattern to the sub mask layer and inversion liftoff layer, thereby exposing the surface of the mask layer to depressions,

(6-1C) forming an inversion layer on the inversion liftoff layer and the exposed surface of the mask layer, and removing the inversion liftoff layer, thereby forming, on the surface of the mask layer, an inversion layer having a projections pattern obtained by inverting the depressions pattern,

(7-1C) transferring the projections pattern to the mask layer,

(7-2C) transferring the projections pattern to the liftoff layer and magnetic recording layer, and

(7-3C) removing the liftoff layer.

The magnetic recording medium manufacturing method according to the fourth embodiment is an example of the magnetic recording medium manufacturing method according to the first embodiment, and includes the steps of sequentially forming the liftoff layer, mask layer, inversion liftoff layer, and sub mask layer on the magnetic recording layer.

The layer formed directly below the inversion liftoff layer and exposed is the mask layer.

The depressions pattern is transferred to the sub mask layer and inversion liftoff layer at once.

The projections pattern can be transferred to the mask layer before being transferred to the magnetic recording layer.

The projections pattern can be transferred to the liftoff layer and magnetic recording layer at once.

The mask layer can be removed by removing the liftoff layer.

In each of the first to fourth embodiments, a magnetic recording medium including a magnetic recording layer having a good projections pattern can be obtained by easily inverting a depressions pattern formed in a pattern formation layer. In addition, the pattern reproducibility is high because unnecessary products can completely be removed during pattern inversion.

The pattern formation layer used in the magnetic recording medium manufacturing methods according to the first to fourth embodiments can be formed by using a self-organizing material selected from a porous material such as mesoporous silica, porous alumina, or porous titania, a diblock copolymer, and a eutectic structure, or a resist material.

When forming the pattern formation layer by using a self-organizing material, the step of patterning the pattern formation layer includes removing one of the phases of a material phase-separated by a self-organization phenomenon.

When forming the pattern forming layer by using a resist, the step of patterning the pattern formation layer includes forming a depressions pattern by pressing a stamper (mold) having a projections pattern against the pattern formation layer, and releasing the stamper after exposure.

A micropattern manufacturing method according to the fifth embodiment includes the steps of

forming an inversion liftoff layer on a substrate,

forming a pattern formation layer on the inversion liftoff layer,

forming a depressions pattern by patterning the pattern formation layer,

transferring the depressions pattern to the inversion liftoff layer, and removing the inversion liftoff layer from depressions,

forming an inversion layer on the inversion liftoff layer and substrate, and removing the inversion liftoff layer, thereby forming, on the substrate, an inversion layer having a projections pattern obtained by inverting the depressions pattern, and

transferring the projections pattern to the substrate.

### <Pattern Formation Layer>

The depressions pattern used in the embodiments is formed by a self-organization method, lithography using an electron beam (EB) or the like, or duplication by a method such as imprinting. When using imprinting, identical patterns can be formed at a high takt.

Examples of the self-organization method are methods using, as the pattern formation layer, a phase-separated structure of an organic material such as a block copolymer, nanostructure materials such as mesoporous silica, porous alumina, and porous titania, and a eutectic structure such as Al—Si.

FIG. 1 is a view showing an example of a depressions pattern formed by self-organizing materials.

When using these self-organizing materials, a large area can be patterned at once. Therefore, a uniform pattern as shown in FIG. 1 can be formed at a pitch of a few nm to a few ten nm at once in a large area. When a pattern like this can be formed with good size dispersion by self-organization, the medium is applicable to various uses such as an HDD. Also, a desired pattern can be formed on an EB resist by EB lithography.

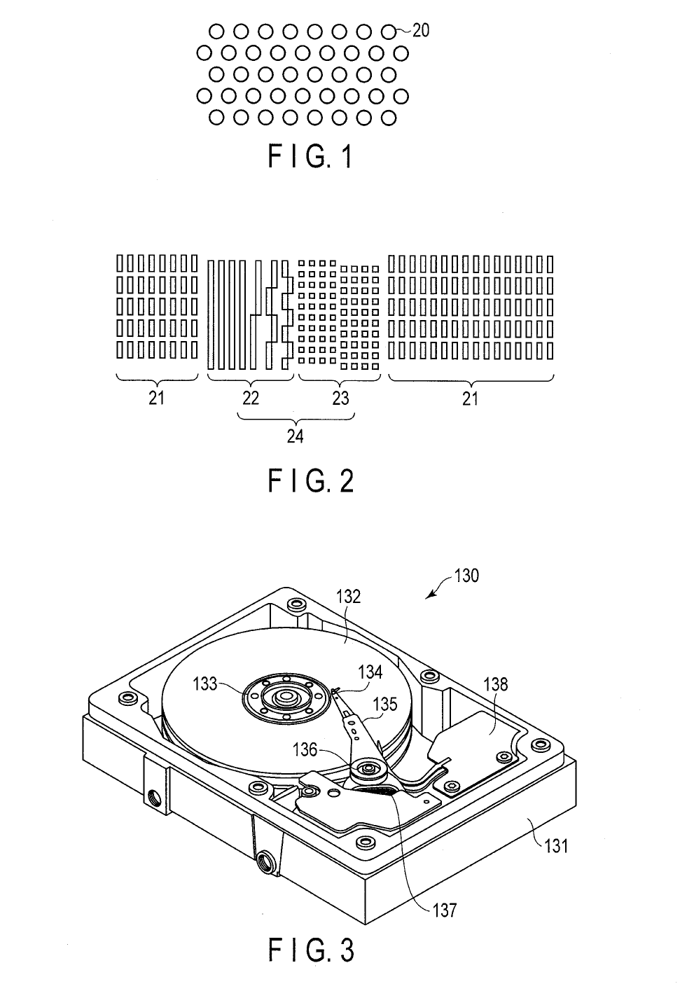

FIG. 2 is a front view showing examples of bit patterned medium (BPM) three-dimensional patterns formed by EB lithography.

As shown in FIG. 2, the examples of the EB lithography patterns are a bit pattern 21 formed in a data area, and servo area patterns 24 formed in a servo area and including a preamble address pattern 22 and bust pattern 23.

For an HDD, the patterns as shown in FIG. 1 or FIG. 2 can be drawn. Since the drawing rate of EB lithography is generally low, a general method is to use a master template made of Si or quartz, and duplicate patterns by a method such as imprinting. It is also possible to use a combined method of drawing only the servo patterns by EB lithography, and arranging a self-organizing material on a three-dimensional guide or chemical guide formed by imprinting.

### <Mesoporous Silica>

Mesoporous silica is a silica compound containing siloxane as a group. Although various synthesizing methods are available, two types of simple methods can be used in the embodiments.

One is a liquid phase method (C. T. Kresge et al., Nature Vol. 359, P. 710 (1992)). After spherical or columnar micelles are formed by sufficiently dispersing a triblock copolymer as a template in water and ethanol as solvents, silica is condensed around the micelles by mixing TEOS or TMOS (tetramethoxysilane) and a catalyst such as C₁₂H₂₅(CH₃)₃N⁺. After that, the dispersion is applied by spin coating and arranged by self-organization by drying. Since the silica micelles are gradually arranged by capillarity during drying, drying can be performed at room temperature for 6 to 20 hrs.

The other is a vapor phase method (N. Nishiyama et al., Chem. Mater. Vol. 15, P. 1,006 (2003)). Although a block copolymer is used as a template as in the above-mentioned liquid phase method, a substrate is coated with a film of the block copolymer in advance, and vaporized TEOS is allowed to enter the block copolymer and formed into micelles in the form of a film.

After silica is arranged, the block copolymer is decomposed by baking at a temperature of about 400° C. to 600° C. in an ordinary method. Although it depends on the material of the magnetic recording layer, when the magnetic recording layer is made of a material, such as Fe₅₀Pt₅₀ of L1₀ structure, which is ordered by heating, baking can also be used as ordering of the magnetic recording layer. In this case, a step of removing the block copolymer in a later process can be omitted. When using a material such as Co₈₀Pt₂₀, modification of the magnetic recording layer occurs at a high temperature. If this is the case, baking can be performed at a low temperature of 300° C. or less in order to completely remove the solvent.

Examples of this patent will be described by using mesoporous silica. However, it is also possible to use, e.g., Al₂O₃, TiO₂, ZrO₂, Ta₂O₅, or Nb₂O₅ as a template instead of silica (SiO₂).

### <Block Copolymer>

Many block copolymers such as a diblock copolymer and triblock copolymer form dot patterns desired in the embodiments. When forming dots as projections, the material of a block copolymer is normally determined so as to increase the etching selectivity of prospective dot portions. Typical examples are PS-PFDMS (Polystyrene-Polyferrocenyldimethylsilane) and PS-PDMS (Polystyrene-Polydimethylsiloxane).

When forming phase-separated patterns at a pitch of about 10 nm by using a block copolymer, there is a material incapable of ensuring the etching rate although phase separation can occur if the material is used. Examples of the material are PS-PEO (Polystyrene-Polyethyleneoxide) and PMMA-POSS (Polymethylmethacrylate-Polyhedral oligomeric silsesquioxane). These materials increase the etching rate of dot portions and decrease that of a sea portion surrounding the dots, but the sea-island structure can be inverted by using the methods according to the embodiments. Note that the pitch is as large as a few ten to a few hundred nm, but the methods according to the embodiments are applicable even when using PS-PMMA (Polystyrene-Polymethylmethacrylate).

Normally, a block copolymer is dispersed in a solvent such as PGMEA and evenly applied on a substrate by spin coating. The block copolymer is then heated at about 200° C. or less, or left to stand in a solvent ambient, thereby obtaining a periodic phase-separated structure.

### <Eutectic Structure>

A phase-separated structure exists in an inorganic material, as well as in an organic material such as a block copolymer. A phase-separated crystal structure like this is called “eutectic”. The eutectic structure is formed by deposition or sputtering of two or more types of elements. Typical examples are eutectic structures of Al—Ge and Al—Si (K. ukutani et al., Adv. Mater. Vol. 16, P. 1,457 (2004)). For example, a target three-dimensional structure is obtained by using an Al—Si target in which Al is formed into a cylindrical shape. The composition ratio of the target can be set to about Al₅₀Si₅₀ to Al₆₀Si₄₀. When dipping Al—Si in 5-wt % phosphoric acid for a few hours, it is possible to selectively remove only Al without dissolving Si.

### <Imprinting>

A mold having a projections pattern and a resist are used in imprinting. A substrate having a mask is coated with an imprint resist, and a mold is brought into contact with the resist. After the resist is cured, the mold is released. Although UV imprinting that cures a resist with light is recently generally used, it is also possible to use thermal imprinting such as a method that cures a resist with heat, or a method that softens a resist with heat, brings a mold into contact with the resist, and cures the resist by cooling. Various materials are used as a mold. For UV imprinting, quartz or a resin that transmits light is used. For thermal imprinting, Si or Ni is used as a main material.

In imprinting, a shape is formed more easily when dots are formed as depressions than when they are formed as projections after imprinting. This tendency is particularly notable for micropatterns. Accordingly, the methods according to the embodiments are applicable even when it is necessary to invert the three-dimensional structure of an imprint pattern.

### <Inversion Liftoff Layer>

The inversion liftoff layer is formed between the magnetic recording layer to be processed into a three-dimensional shape and the pattern layer as a master.

When a protective layer or the like is formed on the magnetic recording layer to be processed into a three-dimensional shape, the inversion liftoff layer can be formed on this protective layer.

The inversion liftoff layer can be made of an inorganic compound and removable by a wet process. After an inversion layer is buried in depressions, the inversion liftoff layer is removed from exposed side surfaces by wet etching.

As the material of the inversion liftoff layer, it is possible to select a material such as Mo, W, Cr, or a compound of any of these elements removable by an acid. These materials can easily be etched by, e.g., hydrogen peroxide, hydrochloric acid, or nitric acid, and can clearly be removed within short time periods.

Also, Al, Ge, Zn, Sn, or a compound of any of these elements can be removed with an alkali. These materials can easily be etched with an alkali such as an aqueous sodium hydroxide solution or aqueous potassium hydroxide solution.

In the embodiments, it is possible to invert the three-dimensional structure of even a three-dimensional pattern that cannot be removed by resist dissolution or O₂ asking.

The inversion liftoff layer is patterned by using an RIE apparatus. When the material is Mo, W, or Ge, a fluorine-based gas such as CF₄ can be used. When the material is Al or Cr, a chlorine-based gas such as Cl₂ can be used. When using Zn or Sn as the material, it is also possible to use ion milling by Ar gas. The second hard mask layer can be formed on the inversion liftoff layer. In this case, the inversion liftoff layer and second hard mask layer can be patterned in the same process depending on the combination of these layers.

### <Liftoff Layer>

The same material, arrangement, and process as those of the inversion liftoff layer can be used for the liftoff layer. It is also possible to use an organic film such as a resist. When using a resist, it is possible to use RIE by O₂ gas or CF₄ gas in processing, and an organic solvent such as acetone or PGMEA in removal.

### <Mask Layer>

On the magnetic recording layer, the first hard mask can be formed as a mask layer as needed. The first hard mask makes it possible to ensure the height of the mask, and raise the taper of a pattern.

The first hard mask is obtained by depositing at least one film on the recording layer by sputtering or the like. When the first hard mask requires a height to some extent, the first hard mask can have a structure including two or more layers. For example, a mask having a high aspect can be formed by using C (carbon) as the lower layer and Si as the upper layer. Alternatively, when using a metal such as Ta, Ti, Mo, or W or a compound of any of these metals as the lower layer, a material such as Ni or Cr can be used as the upper layer. The use of a metal material as the mask has the advantage that the deposition rate increases.

### <Sub Mask Layer>

On the inversion liftoff layer, the second hard mask layer can be formed as a sub mask layer as needed. The formation of the second hard mask has the effect of preventing shape deterioration when transferring the master pattern to the inversion liftoff layer. This makes the pattern shape of the inversion layer clearer.

The material and patterning process of the second hard mask are the same as those of the first hard mask. In particular, the second hard mask can be made of a material that increases the etching selectivity when transferring the master pattern of the pattern formation layer to the second hard mask, or when transferring the pattern from the second hard mask to the inversion liftoff layer. For example, Si is used as the second hard mask when using mesoporous silica. Since the relationship between the etching rates when using CF₄ gas is silica>Si (the second hard mask)>Mo (the inversion liftoff layer), the processed shape can be improved by sandwiching Si between silica and Mo even when processing from silica to Mo is difficult. Also, when using C as the second hard mask, it is possible to process the inversion liftoff with a sufficient selectivity by changing processes in the order that the depressions of silica are patterned by CF₄ gas, the depressions of C are patterned by O₂, and Mo is patterned by CF₄ again.

### <Patterning of First and Second Hard Masks>

The first and second hard masks can be patterned by using various dry etching processes as needed. For example, as described in examples, when using C as the first hard mask and Si as the second hard mask, the second hard mask can be processed by dry etching using a halogen gas (CF₄, CF₄/O₂, CHF₃, SF₆, or Cl₂). After that, the first hard mask may be processed by dry etching by using an oxygen-based gas such as O₂ or O₃, or a gas such as H₂ or N₂. When using a Cr or Al compound as the first or second hard mask, a Cl-based gas can be used. When using Ta, Ti, Mo, or W as the first or second hard mask, the same halogen gas as that usable for Si can be used.

### <Inversion Layer>

The inversion layer is used to invert the three-dimensional shape of the master pattern. The material may has selectivity to the inversion liftoff layer and first hard mask. For example, when the inversion liftoff layer is made of a material such as Mo or W that is easily processed by CF₄ gas, the inversion layer may be selected from, Al, Cr, Cu, Ni, Pd, Ru, and alloys, oxides, nitrides, and the like mainly containing these elements. When the inversion liftoff layer is made of a material such as Al or Cr that is easily processed by a Cl₂-based gas, the inversion layer can be Ti or Si having an acid resistance, or a compound, oxide, nitride, or the like mainly containing Ti or Si.

The inversion layer used in the embodiments is supposed to be used together with the liftoff layer, and is desirably deposited not on sidewalls but in depressions. For example, a deposition method such as sputtering, ALD (Atomic Layer Deposition), or CVD (Chemical Vapor Deposition) is used. Compared to ALD and CVD, sputtering has the advantage that a film is hardly deposited on sidewalls. ALD and CVD have the advantage that a film is easily deposited on the bottoms of narrow depressions, although the film is also deposited on sidewalls. If the inversion layer is deposited on sidewalls and may obstruct a later removing step, this inversion layer on the sidewalls can also be removed by ion milling or the like. The thickness of the inversion layer may be smaller than that of the inversion liftoff layer, because a removing solution is required to enter the inversion liftoff layer. Also, the thickness of the inversion layer may be 1 nm or more because the strength as a film cannot be maintained if the thickness is smaller than 1 nm.

### <Patterning of Magnetic Recording Layer>

The magnetic recording layer is patterned by etching unmasked portions by ion milling or RIE, thereby forming a three-dimensional pattern on the recording layer. A three-dimensional pattern is often formed by entirely etching the material of the recording layer. However, it is also possible, as needed, to form a structure in which the material of the recording layer is partially left behind in depressions, or a capped structure in which the first layer is entirely etched and layers from the second layer are left behind.

In ion milling, it is possible to use a rare gas such as Ne, Ar, Kr, or Xe, or an inert gas such as N₂. When performing RIE, a Cl₂-based gas, CH₃OH gas, NH₃+CO gas, or the like is used. After RIE, it is possible to perform H₂ gas cleaning, baking, or water washing.

### <Removing Solution>

The removing solution may be capable of dissolving the above-mentioned liftoff layer. Examples can be weak acids such as a hydrogen peroxide solution and formic acid. By contrast, hydrochloric acid can be unfavorable because it forms pores in the surface. It is also possible to use, e.g., nitric acid, sulfuric acid, or phosphoric acid in a high-pH region. The pH can be 3 to 6.

After the magnetic recording layer is patterned, the medium is dipped in the removing solution and held in it for a few sec to a few min. After the liftoff layer and mask are sufficiently dissolved, the medium surface is washed with pure water, and the medium is transferred to a later step.

### <Filling Step>

In the methods according to the embodiments, it is possible to add a process of planarizing the magnetic recording layer having the projections pattern by filling. As this filling, sputtering using a filling material as a target is used because the method is simple. However, it is also possible to use, e.g., ion beam deposition, CVD, or ALD. When using CVD or ALD, the filling material can be deposited at a high rate on the sidewalls of the highly tapered magnetic recording layer. Also, even a high-aspect pattern can be filled without any gap by applying a bias to the substrate during filling deposition. It is also possible to use a method by which a so-called resist such as SOG (Spin-On-Glass) or SOC (Spin-On-Carbon) is formed by spin coating and cured by annealing.

The filling material is not limited to SiO₂ and can be any material as long as the hardness and flatness are allowable. For example, an amorphous metal such as NiTa or NiNbTi can be used as the filling material because the amorphous metal is easy to planarize. A material (e.g., CNₓ or CHₓ) mainly containing C can be used because the material has high hardness and high adhesion to DLC. It is also possible to use an oxide or nitride such as SiO₂, SiNₓ, TiOₓ, or TaOₓ as the filling material. However, if the filling material forms a reaction product together with the magnetic recording layer when brought into contact with the magnetic recording layer, a protective layer can be sandwiched between the filling layer and magnetic recording layer.

### <Protective Film Formation and Post-Process>

The carbon protective film can be formed by CVD in order to improve the coverage for the three-dimensional structure. Alternatively, the protective film can be deposited by sputtering or vacuum deposition. A DLC film containing a large amount of sp³-bonded carbon can be formed by CVD. If the film thickness is 2 nm or less, the coverage worsens. If the film thickness is 10 nm or more, the magnetic spacing between a recording/reproduction head and the medium increases, and the SNR decreases. The protective film can be coated with a lubricant. As the lubricant, it is possible to use, e.g., perfluoropolyether, alcohol fluoride, or fluorinated carboxylic acid.

### <Magnetic Recording Layer>

When using alloy-based materials, the magnetic recording layer mainly contains Co, Fe, or Ni, and can also contain Pt or Pd. The magnetic recording layer can contain Cr or an oxide as needed. As the oxide, it is possible to use particularly silicon oxide or titanium oxide. In addition to the oxide, the magnetic recording layer can further contain one or more elements selected from Ru, Mn, B, Ta, Cu, and Pd. These elements can improve the crystallinity and orientation, and make it possible to obtain recording/reproduction characteristics and thermal fluctuation characteristics more suitable for high-density recording.

As the perpendicular magnetic recording layer, it is possible to use a CoPt-based alloy, an FePt-based alloy, a CoCrPt-based alloy, an FePtCr-based alloy, CoPtO, FePtO, CoPtCrO, FePtCrO, CoPtSi, FePtSi, and a multilayered structure including Co, Fe, or Ni and an alloy mainly containing at least one element selected from the group consisting of Pt, Pd, Ag, and Cu. It is also possible to use a MnAl alloy, SmCo alloy, FeNbB alloy, or CrPt alloy having a high Ku.

The thickness of the perpendicular magnetic recording layer can be 3 to 30 nm, and further can be, to 15 nm. When the thickness falls within this range, it is possible to manufacture a magnetic recording/reproduction apparatus more suitable for a high recording density. If the thickness of the perpendicular magnetic recording layer is less than 3 nm, the reproduced output is too low, and the noise component becomes higher. If the thickness of the perpendicular magnetic recording layer exceeds 30 nm, the reproduced output becomes too high and distorts the waveform.

### <Interlayer>

An interlayer made of a nonmagnetic material can be formed between the soft under layer and recording layer. The interlayer has two functions: one is to interrupt the exchange coupling interaction between the soft under layer and recording layer; and the other is to control the crystallinity of the recording layer. As the material of the interlayer, it is possible to use Ru, Pt, Pd, W, Ti, Ta, Cr, Si, Ni, Mg, an alloy containing any of these elements, or an oxide or nitride of any of these elements.

### <Soft Under Layer>

A soft under layer (SUL) horizontally passes a recording magnetic field from a single-pole head for magnetizing the perpendicular magnetic recording layer, and returns the magnetic field toward the magnetic head, i.e., performs a part of the function of the magnetic head. The soft under layer has a function of applying a steep sufficient perpendicular magnetic field to the recording layer, thereby increasing the recording/reproduction efficiency. A material containing Fe, Ni, or Co can be used as the soft under layer. Examples of the material are FeCo-based alloys such as FeCo and FeCoV, FeNi-based alloys such as FeNi, FeNiMo, FeNiCr, and FeNiSi, FeAl-based and FeSi-based alloys such as FeAl, FeAlSi, FeAlSiCr, FeAlSiTiRu, and FeAlO, FeTa-based alloys such as FeTa, FeTaC, and FeTaN, and FeZr-based alloys such as FeZrN. It is also possible to use a material having a microcrystalline structure or a granular structure in which fine crystal grains are dispersed in a matrix. Examples are FeAlO, FeMgO, FeTaN, and FeZrN containing 60 at % or more of Fe. Other examples of the material are Co alloys containing Co and at least one of Zr, Hf, Nb, Ta, Ti, and Y. The Co alloy may contain 80 at % or more of Co. When the Co alloy like this is deposited by sputtering, an amorphous layer readily forms. The amorphous soft magnetic material has none of magnetocrystalline anisotropy, a crystal defect, and a grain boundary, and hence has very high soft magnetism and can reduce the noise of the medium. Examples of the amorphous soft magnetic material are CoZr-, CoZrNb-, and CoZrTa-based alloys.

It is also possible to additionally form a base layer below the soft under layer, in order to improve the crystallinity of the soft under layer or improve the adhesion to the substrate. As the material of this base layer, it is possible to use Ti, Ta, W, Cr, Pt, an alloy containing any of these elements, or an oxide or nitride of any of these elements.

Furthermore, in order to prevent spike noise, it is possible to divide the soft under layer into a plurality of layers, and insert 0.5- to 1.5-nm thick Ru, thereby causing antiferromagnetic coupling. The soft magnetic layer may also be exchange-coupled with a hard magnetic film having in-plane anisotropy such as CoCrPt, SmCo, or FePt, or a pinned layer made of an antiferromagnetic material such as IrMn or PtMn. To control the exchange coupling force, it is possible to stack magnetic films (e.g., Co) or nonmagnetic films (e.g., Pt) on the upper and lower surfaces of the Ru layer.

FIG. 3 is a partially exploded perspective view showing an example of a magnetic recording/reproduction apparatus to which the magnetic recording medium according to the embodiment is applicable.

As shown in FIG. 3, a magnetic recording/reproduction apparatus 130 includes a rectangular boxy housing 131 having an open upper end, and a top cover (not shown) that is screwed to the housing 131 by a plurality of screws and closes the upper-end opening of the housing.

The housing 131 houses, e.g., a magnetic recording medium 132 according to the embodiment, a spindle motor 133 as a driving means for supporting and rotating the magnetic recording medium 132, a magnetic head 134 for recording and reproducing magnetic signals with respect to the magnetic recording medium 132, a head actuator 135 that has a suspension on the distal end of which the magnetic head 134 is mounted, and supports the magnetic head 134 such that it can freely move with respect to the magnetic recording medium 132, a rotating shaft 136 for rotatably supporting the head actuator 135, a voice coil motor 137 for rotating and positioning the head actuator 135 via the rotating shaft 136, and a head amplifier circuit board 138. The embodiments will be explained in more detail below by way of its examples.

### EXAMPLES

### Example 1

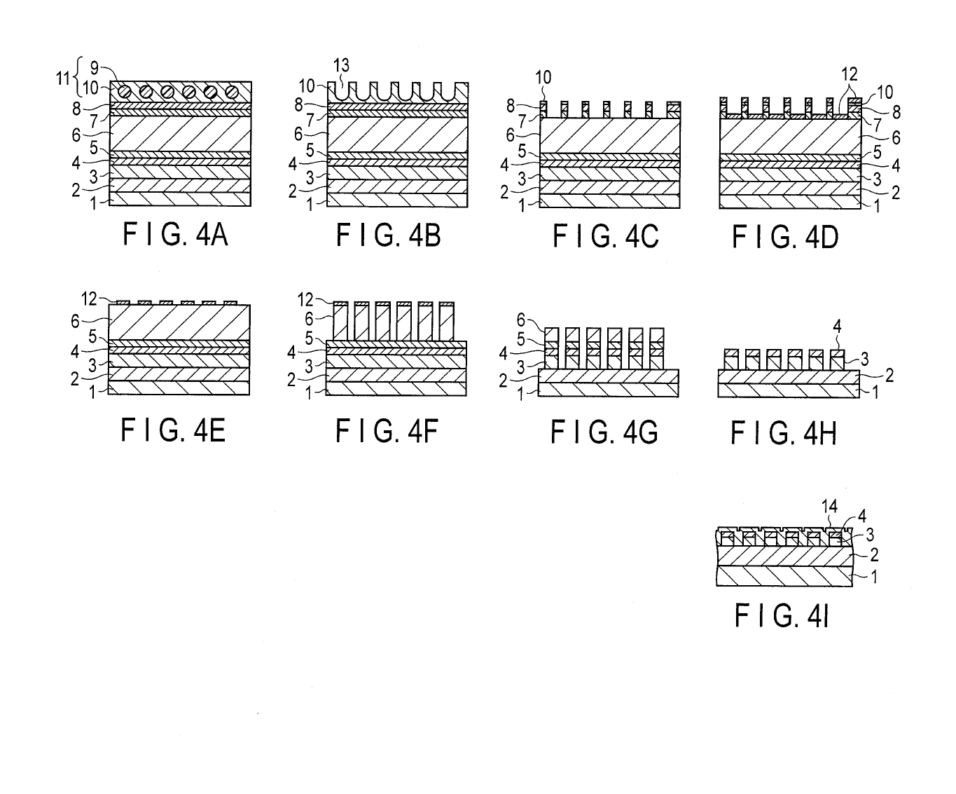

An example of the medium manufacturing method according to the fourth embodiment will be explained below with reference to FIGS. 4A, 4B, 4C, 4D, 4E, 4F, 4G, 4H, and 4I.

In this example, mesoporous silica was used as a self-organizing material in order to form a pattern formation layer.

As shown in FIG. 4A, a 40-nm thick CoZrNb soft magnetic layer (not shown), 20-nm thick orientation control Ru interlayer 2, 10-nm thick Co₈₀Pt₂₀ magnetic recording layer 3, 2-nm thick Pd protective film 4, 5-nm thick liftoff layer 5 made of Mo, 20-nm thick first hard mask layer 6 made of C, 3-nm thick inversion liftoff layer 7 made of Mo, and 3-nm thick second hard mask layer 8 made of Si were deposited on a glass substrate 1.

The substrate was coated with a mesoporous silica solution and left to stand at room temperature for 12 hrs, thereby arranging silica spheres. The mesoporous silica was prepared by mixing, e.g., TEOS (Tetraethyoxysilane), triblock copolymer PEO₈₀-PPO₃₀-PEO₈₀, HCl, ethanol, and water at a molar ratio of 1.0:0.15:0.015:3.5:8.2, and stirring the mixture at room temperature for 3 hrs. A mesoporous silica coating layer 11 was formed by coating the substrate with the obtained solution by spin coating. The solution was diluted to six times the volume with PGMEA (Propylene Glycol Methyl Ether Acetate), so that the silica spheres were arranged into a single layer. When the mesoporous silica coating layer 11 was observed with a planar SEM after coating, a dot arrangement as shown in FIG. 1 was found. That is, the triblock copolymer existed inside spheres 9, and the spheres 9 were covered with a silica phase 10.

Note that triblock copolymer PEO₈₀-PPO₃₀-PEO₈₀ is a copolymer of PEO (PolyEthylene Oxide) and PPO (PolyPropylene Oxide).

Then, as shown in FIG. 4B, the triblock copolymer existing as a template of mesoporous silica inside the spheres 9 was removed, thereby forming a depressions pattern 13 of the silica phase 10. For example, this step was performed by an inductively coupled plasma (ICP)-RIE apparatus by sequentially using CF₄ gas and O₂ gas as process gases for etching times of 10 sec and 10 sec at a chamber pressure of 0.1 Pa, a coil RF power of 50 W, and a platen RF power of 10 W.

As shown in FIG. 4C, the depressions pattern of the silica phase 10 was transferred to the second hard mask layer 8 and inversion liftoff layer 7. This step was similarly performed by the ICP-RIE apparatus by using CF₄ gas as a process gas for an etching time of 50 sec at a chamber pressure of 0.1 Pa, a coil RF power of 100 W, and a platen RF power of 10 W. In this step, the Si sub mask layer 8 and inversion liftoff layer 7 were removed from depressions, and the mask layer 6 immediately below the inversion liftoff layer was exposed.

AS shown in FIG. 4D, an inversion layer 12 made of Ni was formed. For example, this step was performed by sputtering an Ni target by using Ar gas, thereby depositing 2-nm thick Ni on the substrate facing the target for a deposition time of 2 sec at a process gas pressure of 0.3 Pa and a deposition power of 500 W.

As shown in FIG. 4E, projections were removed together with the inversion liftoff layer 7. For example, this step was performed by dipping the substrate in a hydrogen peroxide solution having a pH of 5 and holding the substrate in the solution for 1 min. After dipping, the substrate was washed with pure water. In this step, the projections were removed, and the first hard mask layer 6 was exposed. The Ni inversion layer 12 deposited in the step shown in FIG. 4D and having the projections pattern remained in the region where the depressions pattern 13 existed, thereby inverting the three-dimensional shape.

As shown in FIG. 4F, the shape of the inversion layer 12 was transferred to the first hard mask 6 by using the Ni inversion layer 12 as a mask. This step was performed by the ICP-RIE apparatus by using O₂ gas as a process gas for an etching time of 60 sec at a chamber pressure of 0.1 Pa, a coil RF power of 50 W, and a platen RF power of 5 W.

As shown in FIG. 4G, the shape of the first hard mask 6 was transferred to the liftoff layer 5, protective layer 4, and magnetic recording layer 3 by ion milling. For example, this step was performed by an Ar ion milling apparatus by using Ar as a process gas for an etching time of 10 sec at a chamber pressure of 0.04 Pa, a plasma power of 400 W, and an acceleration voltage of 400 V.

As shown in FIG. 4H, the first hard mask 6 was removed together with the liftoff layer 5 made of Mo. For example, this step was performed by dipping the medium in a 0.1% hydrogen peroxide solution and holding the medium in the solution for 5 min. Consequently, a structure in which the Ru interlayer 2 and the projections pattern made of the magnetic recording layer 3 and protective layer 4 were formed on the glass substrate 1 was obtained.

Finally, as shown in FIG. 4I, a second protective film 14 was formed by CVD (Chemical Vapor Deposition) on the Ru interlayer 2 on which the projections pattern was formed by stacking the magnetic recording layer 3 and protective layer 4, and a lubricant (not shown) was applied, thereby obtaining a patterned medium 100 according to the embodiment.

The planar structure and sectional structure of the patterned medium manufactured by the method as described above were observed with an SEM. Consequently, dots faithfully tracing the dot structure of mesoporous silica as shown in FIG. 1 and having an inverted three-dimensional shape were periodically arranged. Also, when this patterned medium was incorporated into an HDD and the error rate was measured, the error rate was 10⁻⁶ or less. This result reveals that the medium manufactured by the arrangement of this patent had sufficient performance as a patterned medium.

### Comparative Example 1

A magnetic recording medium was manufactured following the same procedures as in Example 1 except that the second hard mask 8 was directly deposited on the first hard mask 6 without forming any inversion liftoff layer 7, and mesoporous silica and Si were removed by RIE using CF₄ gas without performing the removal of the inversion liftoff layer 7 as shown in FIG. 4E. Note that the RIE step using CF₄ gas was performed for an etching time of 30 sec at a chamber pressure of 0.1 Pa, a coil RF power of 50 W, and a platen RF power of 10 W.

The planar structure and sectional structure of the patterned medium manufactured by the method as described above were observed with an SEM. Consequently, dots having an inverted three-dimensional shape were periodically arranged, but these dots were not divided but connected. When a sampling test was conducted during the process, mesoporous silica and Si were not sufficiently removed after the inversion layer was deposited. These results indicate that dots are sufficiently divided by forming the inversion liftoff layer.

### Example 2

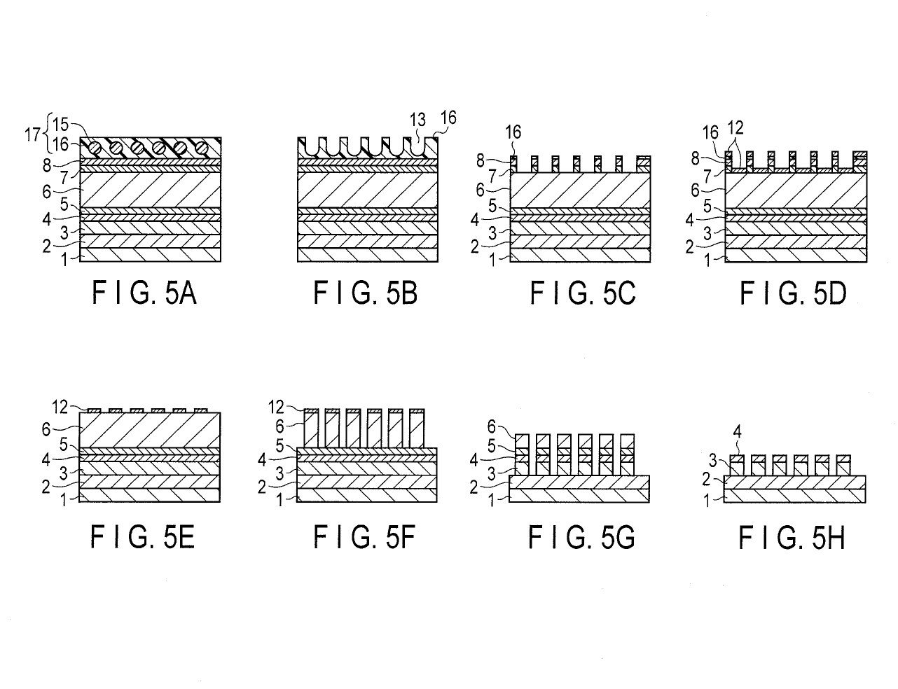

Another example of the medium manufacturing method according to the fourth embodiment will be explained below with reference to FIGS. 5A, 5B, 5C, 5D, 5E, 5F, 5G, and 5H.

In this example, a diblock copolymer was used as a self-organizing material in order to form a pattern formation layer.

Note that FIGS. 5E, 5F, 5G, and 5H are the same steps as those shown in FIGS. 4E, 4F, 4G, and 4H, so a repetitive explanation will be omitted.

As shown in FIG. 5A, a 40-nm thick CoZrNb soft magnetic layer (not shown), 20-nm thick Ru orientation control interlayer 2, 10-nm thick Co₇₅Pt₂₅ magnetic recording layer 3, 2-nm thick CoCrPt protective film 4, 5-nm thick liftoff layer 5 made of Mo, 20-nm thick first hard mask layer 6 made of C, 3-nm thick inversion liftoff layer 7 made of W, and 3-nm thick second hard mask layer 8 made of C were deposited on a glass substrate 1. The second hard mask layer 8 was spin-coated with a coating solution prepared by dissolving PS-PEO (Polystyrene-Polyethyleneoxide) in a solvent, thereby forming a coating film 17 as a single layer. The molecular weights of PS and PEO were respectively 9,500 and 18,000. From this composition, a sphere-like micro phase-separated structure equivalent to a pitch of 30 nm was obtained. In this micro phase-separated structure, a PEO phase 15 was phase-separated into spheres, and covered with a PS phase 16. 1,2-diethoxyethane (Diethylene Glycol Dimethyl Ether) was used as the solvent, and the coating solution was prepared such that the mass percent concentration was 1.0%.

As shown in FIG. 5B, a depressions pattern 13 of the PS phase 16 was formed by removing the PEO phase 15 existing in dot portions. For example, this step was performed by an ICP-RIE apparatus by using O₂ gas as a process gas for an etching time of 10 sec at a chamber pressure of 0.1 Pa, a coil RF power of 50 W, and a platen RF power of 10 W.

As shown in FIG. 5C, the depressions pattern 13 of the remaining PS phase 16 was transferred to the second hard mask layer 8 and inversion liftoff layer 7. This step was similarly performed by the ICP-RIE apparatus by sequentially using O₂ gas and CF₄ gas as process gases for etching times of 10 sec and 30 sec at a chamber pressure of 0.1 Pa, a coil RF power of 50 W, and a platen RF power of 10 W. In this step, the C layer 8 and Mo layer 7 were removed from depressions, and the C mask layer 6 as an underlying layer was exposed.

After that, as shown in FIG. 5D, an inversion layer 12 made of Ni was formed. For example, this step was performed by sputtering an Ni target by using Ar gas, thereby depositing 2-nm thick Ni on the substrate facing the target for a deposition time of 2 sec at a process gas pressure of 0.3 Pa and a deposition power of 500 W.

Since FIGS. 5E, 5F, 5G, and 5H are the same steps as those shown in FIGS. 4E, 4F, 4G, and 4H, a repetitive explanation will be omitted.

Finally, as shown in FIG. 4I, a second protective film 14 was formed by CVD (Chemical Vapor Deposition) on the Ru interlayer 2 on which the projections pattern was formed by stacking the magnetic recording layer 3 and protective layer 4, and a lubricant (not shown) was applied, thereby obtaining a patterned medium according to the embodiment.

The planar structure and sectional structure of the patterned medium manufactured by the method as described above were observed with an SEM. Consequently, dots faithfully tracing the dot structure as shown in FIG. 1 and having an inverted three-dimensional shape were periodically arranged. Also, when this patterned medium was incorporated into an HDD and the error rate was measured, the error rate was 10⁻⁶ or less. This result reveals that the medium manufactured by the arrangement of this patent had sufficient performance as a patterned medium.

### Example 3

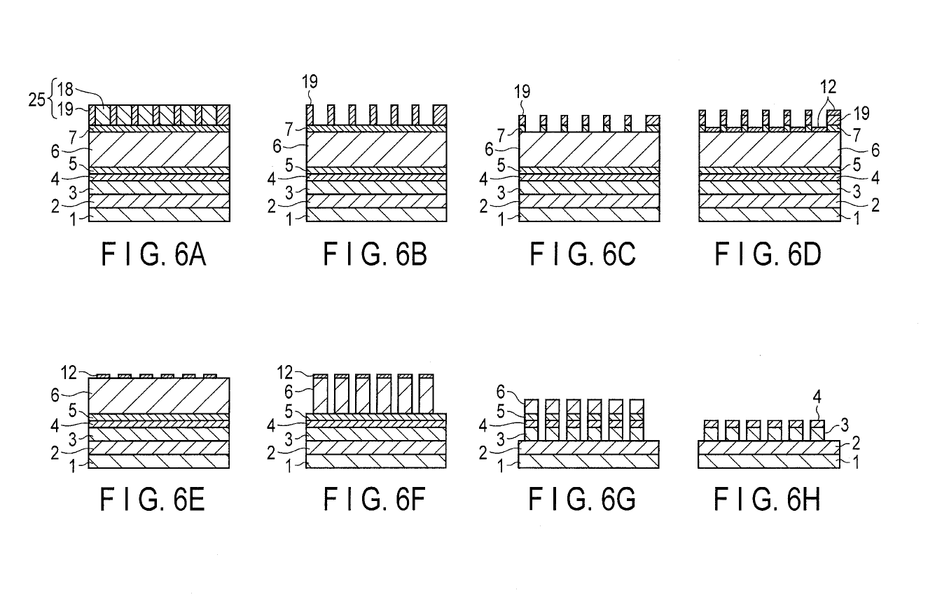

An example of the medium manufacturing method according to the third embodiment will be explained below with reference to FIGS. 6A, 6B, 6C, 6D, 6E, 6F, 6G, and 6H.

In this example, a eutectic structure was used as a self-organizing material in order to form a pattern formation layer.

Note that FIGS. 6E, 6F, 6G, and 6H are the same steps as those shown in FIGS. 4E, 4F, 4G, and 4H, so a repetitive explanation will be omitted.

As shown in FIG. 6A, a 40-nm thick CoZrNb soft magnetic layer (not shown), 5-nm thick Pt orientation control interlayer 2, 5-nm thick Fe₅₀Pt₅₀ magnetic recording layer 3, 2-nm thick Pt protective film 4, 5-nm thick liftoff layer 5 made of W, 20-nm thick first hard mask layer 6 made of C, and 3-nm thick inversion liftoff layer 7 made of Mo were sequentially deposited on a glass substrate 1. Subsequently, a 10-nm thick Al—Si eutectic film 25 was deposited (see, e.g., Jpn. Pat. Appln. KOKAI Publication No. 2005-60771). By properly adjusting the composition ratio of Al and Si targets during sputtering, it was possible to obtain a structure in which an Si phase 19 was buried around a dot-like Al phase 18 as shown in FIGS. 2 and 6A. In this example, the atomic ratio of the Al and Si targets was Al:Si=55:45. The dot pitch was 15 nm. Note that the dots were seen when the substrate was observed from above by using an SEM, but Al existed in the form of a cylinder in Si when the sectional structure was observed.

As shown in FIG. 6B, a depressions pattern made of the Si phase 19 was formed by removing the dot-like Al phase 18. For example, this step was performed by dipping the substrate in 5-wt % phosphoric acid for 1 hr to remove Al from dot portions, thereby obtaining a depressions pattern having a 10-nm thick porous structure of the Si phase 19.

As shown in FIG. 6C, the depressions pattern of the Si phase 19 was transferred to the inversion liftoff layer 7. This step was performed by an ICP-RIE apparatus by sequentially using CF₄ gas as a process gas for an etching time of 30 sec at a chamber pressure of 0.1 Pa, a coil RF power of 50 W, and a platen RF power of 10 W. Consequently, Mo was removed from depressions, and the hard mask layer 6 as an underlying layer was exposed.

As shown in FIG. 6D, an inversion layer 12 made of Ni was formed. For example, this step was performed by sputtering an Ni target by using Ar gas, thereby depositing 2-nm thick Ni on the substrate facing the target for a deposition time of 2 sec at a process gas pressure of 0.3 Pa and a deposition power of 500 W.

Since FIGS. 6E, 6F, 6G, and 6H are the same steps as those shown in FIGS. 4E, 4F, 4G, and 4H, a repetitive explanation will be omitted.

Finally, as shown in FIG. 4I, a second protective film 14 was formed by CVD (Chemical Vapor Deposition) on the Pt interlayer 2 on which the projections pattern was formed by stacking the magnetic recording layer 3 and protective layer 4, and a lubricant (not shown) was applied, thereby obtaining a patterned medium according to the embodiment.

The planar structure and sectional structure of the patterned medium manufactured by the method as described above were observed with an SEM. Consequently, dots faithfully tracing the dot structure as shown in FIG. 1 and having an inverted three-dimensional structure were periodically arranged. Also, when this patterned medium was incorporated into an HDD and the error rate was measured, the error rate was 10⁻⁶ or less. This result reveals that the medium manufactured by the arrangement of this patent had sufficient performance as a patterned medium.

### Example 4

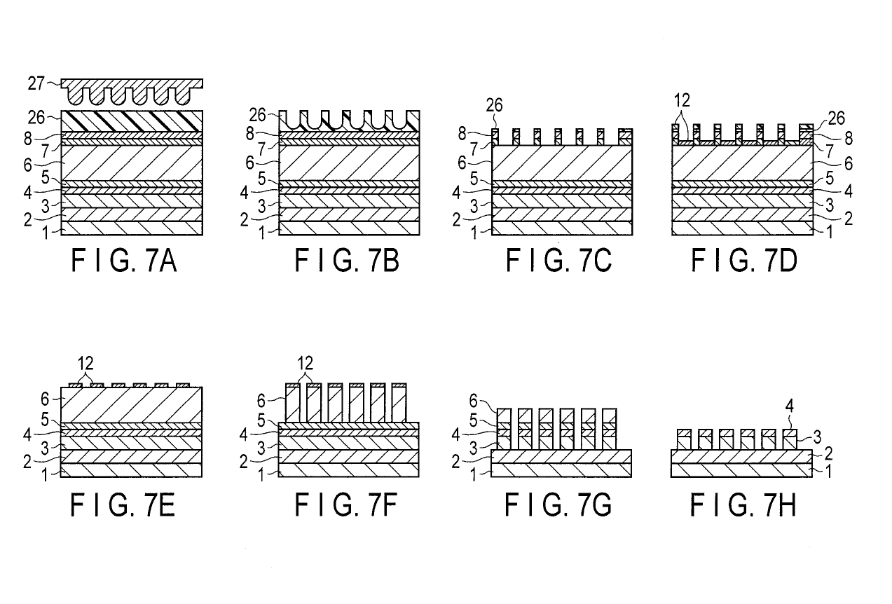

Still another example of the medium manufacturing method according to the fourth embodiment will be explained below with reference to FIGS. 7A, 7B, 7C, 7D, 7E, 7F, 7G, and 7H.

In this example, a resist was used to form a pattern formation layer, and a depressions pattern was formed by nanoimprinting.

Note that FIGS. 7E, 7F, 7G, and 7H are the same steps as those shown in FIGS. 4E, 4F, 4G, and 4H, so a repetitive explanation will be omitted.

As shown in FIG. 7A, a 40-nm thick CoZrNb soft magnetic layer (not shown), 20-nm thick Ru orientation control interlayer 2, 5-nm thick Co₇₅Pt₂₅ magnetic recording layer 3, 2-nm thick Pd protective film 4, 5-nm thick liftoff layer 5 made of Mo, 20-nm thick first hard mask layer 6 made of C, 3-nm thick inversion liftoff layer 7 made of Mo, and 3-nm thick second hard mask layer 8 made of Si were sequentially deposited on a glass substrate 1. Subsequently, the second hard mask 8 was spin-coated with a 30-nm thick photocuring resist 26 to be used in an imprinting step.

As shown in FIG. 7B, a depressions pattern as shown in FIG. 2 was transferred to the resist 26 by nanoimprinting. For example, this step was performed by bringing a quartz stamper 27 having a three-dimensional pattern as an inverted pattern of a desired pattern into close contact with the resist 26, curing the resist 26 by UV irradiation, and releasing the stamper 27 after that.

As shown in FIG. 7C, the depressions pattern of the resist 26 was transferred to the second hard mask layer 8 and inversion liftoff layer 7. This step was performed by an ICP-RIE apparatus by using CF₄ gas as a process gas for an etching time of 50 sec at a chamber pressure of 0.1 Pa, a coil RF power of 50 W, and a platen RF power of 10 W. In this step, the resist 26, second hard mask 8, and inversion liftoff layer 7 were removed from depressions at once, and the hard mask layer 6 as an underlying layer was exposed.

As shown in FIG. 7D, an inversion layer 12 made of Ni was formed. For example, this step was performed by sputtering an Ni target by using Ar gas, thereby depositing 2-nm thick Ni on the substrate facing the target for a deposition time of 2 sec at a process gas pressure of 0.3 Pa and a deposition power of 500 W.

Since FIGS. 7E, 7F, 7G, and 7H are the same steps as those shown in FIGS. 4E, 4F, 4G, and 4H, a repetitive explanation will be omitted.

Finally, as shown in FIG. 4I, a second protective film 14 was formed by CVD (Chemical Vapor Deposition) on the Ru interlayer 2 on which the projections pattern was formed by stacking the magnetic recording layer 3 and protective layer 4, and a lubricant (not shown) was applied, thereby obtaining a patterned medium according to the embodiment.

The planar structure and sectional structure of the patterned medium manufactured by the method as described above were observed with an SEM. Consequently, dots faithfully tracing the quartz stamper 27 having the pattern shape as shown in FIG. 2 and having an inverted three-dimensional structure were periodically arranged. Also, when this patterned medium was incorporated into an HDD and the error rate was measured, the error rate was 10⁻⁶ or less. This result reveals that the medium manufactured by the arrangement of this patent had sufficient performance as a patterned medium.

### Example 5

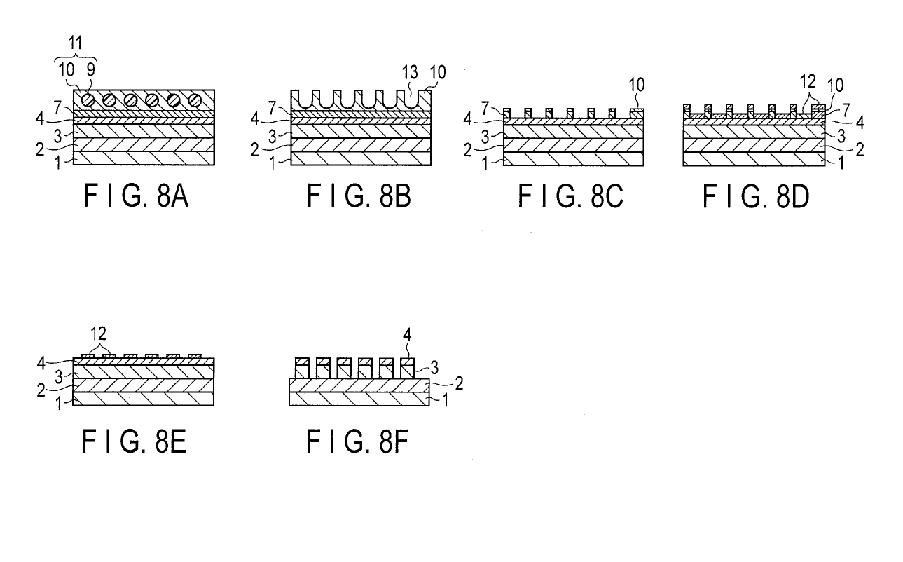

The medium manufacturing method according to the first embodiment will be explained below with reference to FIGS. 8A, 8B, 8C, 8D, 8E, and 8F.

As shown in FIG. 8A, a 40-nm thick CoZrNb soft magnetic layer (not shown), 20-nm thick Ru orientation control interlayer 2, 10-nm thick Co₈₀Pt₂₀ magnetic recording layer 3, 2-nm thick Pd protective film 4, and 3-nm thick inversion liftoff layer 7 made of Mo were deposited on a glass substrate 1.

The inversion liftoff layer 7 was coated with the same mesoporous silica solution as that of Example 1 and left to stand at room temperature for 12 hrs, thereby arranging silica spheres.

When a mesoporous silica coating layer 11 was observed with a planar SEM after coating, a dot arrangement as shown in FIG. 1 was found.

That is, a triblock copolymer existed inside spheres 9, and the spheres 9 were covered with a silica phase 10.

As shown in FIG. 8B, the triblock copolymer existing as a template of mesoporous silica inside the spheres 9 was removed following the same procedure as in Example 1, thereby forming a depressions pattern 13 of the silica phase 10.

As shown in FIG. 8C, the depressions pattern 13 of the silica phase 10 was transferred to the Mo inversion liftoff layer 7. This step was performed by an ICP-RIE apparatus by using CF₄ gas as a process gas for an etching time of 30 sec at a chamber pressure of 0.1 Pa, a coil RF power of 100 W, and a platen RF power of 10 W. In this step, the inversion liftoff layer 7 was removed from depressions, and the Pd protective layer 4 immediately below the inversion liftoff layer 7 was exposed.

As shown in FIG. 8D, an inversion layer 12 made of Al₂O₃, instead of Ni, was formed in the same manner as in Example 1. As shown in FIG. 8E, projections around the depressions pattern 13 were removed together with the inversion liftoff layer 7. In this step, the Pd protective layer 4 was exposed. The Al₂O₃ inversion layer 12 deposited in the step shown in FIG. 8D and having the projections pattern remained in the region where the depressions pattern 13 existed, thereby inverting the three-dimensional shape.

As shown in FIG. 8F, the shape of the inversion layer 12 was transferred to the magnetic recording layer 3 by ion milling by using Al₂O₃ of the inversion layer 12 as a mask. For example, this step was performed by an Ar ion milling apparatus by using Ar as a process gas for an etching time of 10 sec at a chamber pressure of 0.04 Pa, a plasma power of 400 W, and an acceleration voltage of 400 V. When milling was complete, the Al₂O₃ inversion layer 12 was just etched away.

Finally, as shown in FIG. 4I, a second protective film 14 was formed by CVD (Chemical Vapor Deposition) on the Ru interlayer 2 on which the projections pattern was formed by stacking the magnetic recording layer 3 and protective layer 4, and a lubricant (not shown) was applied, thereby obtaining a patterned medium according to the embodiment.

### Example 6

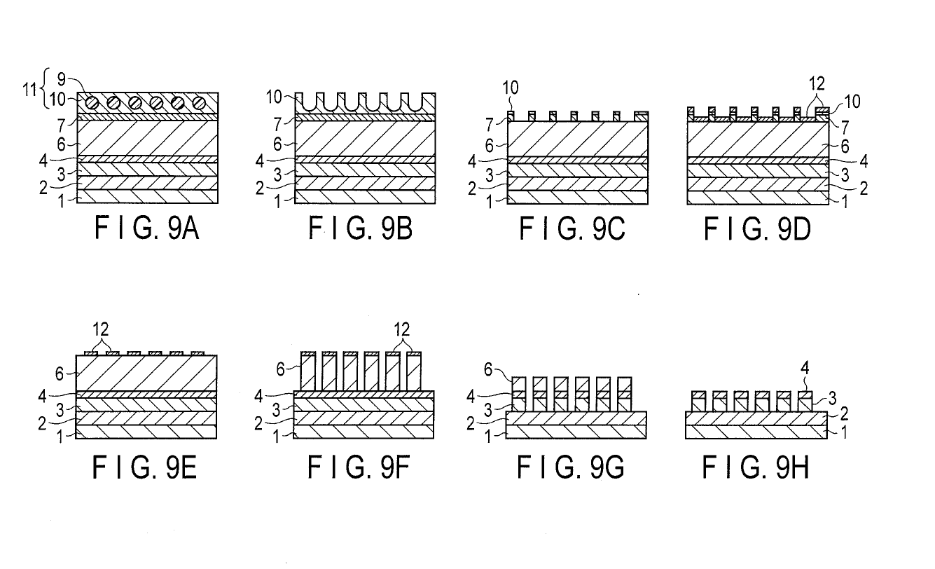

The medium manufacturing method according to the second embodiment will be explained below with reference to FIGS. 9A, 9B, 9C, 9D, 9E, 9F, 9G, and 9H.

As shown in FIG. 9A, a 40-nm thick CoZrNb soft magnetic layer (not shown), 20-nm thick Ru orientation control interlayer 2, 10-nm thick Co₈₀Pt₂₀ magnetic recording layer 3, 2-nm thick Pd protective film 4, 20-nm thick first hard mask layer 6 made of C, and 3-nm thick inversion liftoff layer 7 made of Mo were deposited on a glass substrate 1. Following the same procedure as in Example 1, the inversion liftoff layer 7 was coated with a mesoporous silica solution, and the substrate was left to stand at room temperature for 12 hrs, thereby arranging silica spheres.

When a mesoporous silica coating layer 11 was observed with a planar SEM after coating, a dot arrangement as shown in FIG. 1 was found.

That is, a triblock copolymer existed inside spheres 9, and the spheres 9 were covered with a silica phase 10.

As shown in FIG. 9B, the triblock copolymer existing as a template of mesoporous silica inside the spheres 9 was removed following the same procedure as in Example 1, thereby forming a depressions pattern 13 of the silica phase 10.

As shown in FIG. 9C, the depressions pattern 13 of the silica phase 10 was transferred to the inversion liftoff layer 7. This step was performed by an ICP-RIE apparatus by using CF₄ gas as a process gas for an etching time of 30 sec at a chamber pressure of 0.1 Pa, a coil RF power of 100 W, and a platen RF power of 10 W. In this step, the inversion liftoff layer 7 was removed from depressions, and the first hard mask 6 as an underlying layer was exposed.

As shown in FIGS. 9D and 9E, an inversion layer 12 made of Ni was deposited in the same manner as in Example 1, and projections were removed together with the inversion liftoff layer 7. In this step, the Pd protective layer 4 was exposed. The Ni inversion layer 12 deposited in the step shown in FIG. 9D and having the projections pattern remained in the region where the depressions pattern 13 existed, thereby inverting the three-dimensional shape.

As shown in FIG. 9F, the projections pattern of the inversion layer 12 was transferred to the first hard mask layer 6 by using the Ni of the inversion layer as a mask following the same procedure as in Example 1.

As shown in FIG. 9G, the projections pattern of the first hard mask layer 6 was transferred to the Pd protective layer 4 and magnetic recording layer 3 by ion milling following the same procedure as in Example 1.

As shown in FIG. 9H, the first hard mask 6 was removed. For example, this step was performed by an RIE apparatus by using CF₄ gas as a process gas for an etching time of 60 sec at a chamber pressure of 5.0 Pa, a coil RF power of 0 W, and a platen RF power of 100 W.

Finally, as shown in FIG. 4I, a second protective film 14 was formed by CVD (Chemical Vapor Deposition) on the Ru interlayer 2 on which the projections pattern was formed by stacking the magnetic recording layer 3 and protective layer 4, and a lubricant (not shown) was applied, thereby obtaining a patterned medium according to the embodiment.

### Example 7

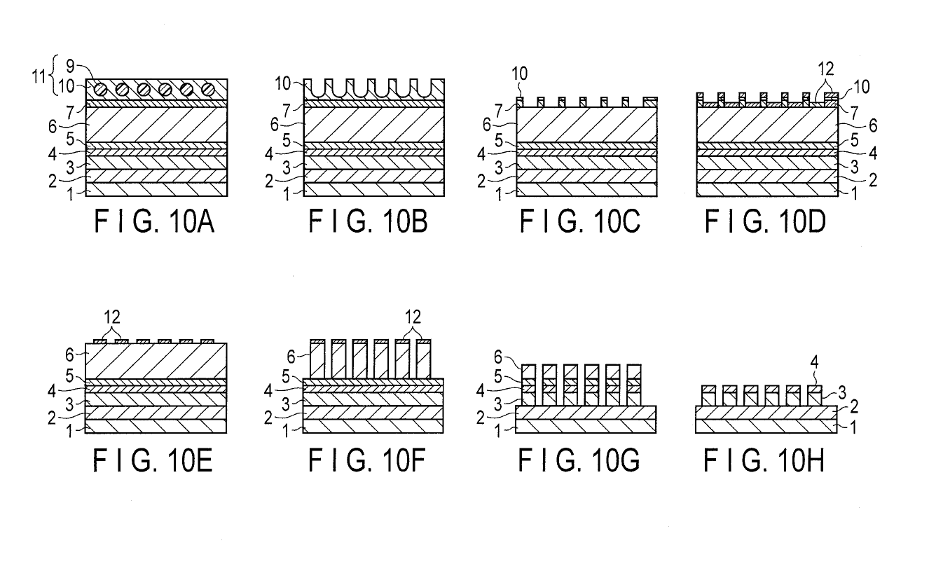

The medium manufacturing method according to the third embodiment will be explained below with reference to FIGS. 10A, 10B, 10C, 10D, 10E, 10F, 10G, and 10H.

As shown in FIG. 10A, a 40-nm thick CoZrNb soft magnetic layer (not shown), 20-nm thick Ru orientation control interlayer 2, 10-nm thick Co₈₀Pt₂₀ magnetic recording layer 3, 2-nm thick Pd protective film 4, 5-nm thick liftoff layer 5 made of Mo, 20-nm thick first hard mask layer 6 made of C, and 3-nm thick inversion liftoff layer 7 made of Mo were deposited on a glass substrate 1. Following the same procedure as in Example 1, the substrate was coated with a mesoporous silica solution and left to stand at room temperature for 12 hrs, thereby arranging silica spheres.

When a mesoporous silica coating layer 11 was observed with a planar SEM after coating, a dot arrangement as shown in FIG. 1 was found.

That is, a triblock copolymer existed inside spheres 9, and the spheres 9 were covered with a silica phase 10.

As shown in FIG. 10B, the triblock copolymer existing as a template of mesoporous silica inside the spheres 9 was removed following the same procedure as in Example 1, thereby forming a depressions pattern 13 of the silica phase 10.

As shown in FIG. 10C, the depressions pattern 13 of the silica phase 10 was transferred to the Mo inversion liftoff layer 7. This step was performed by an ICP-RIE apparatus by using CF₄ gas as a process gas for an etching time of 30 sec at a chamber pressure of 0.1 Pa, a coil RF power of 100 W, and a platen RF power of 10 W. In this step, Mo was removed from depressions, and the first hard mask 6 as an underlying layer was exposed.

As shown in FIG. 10D, an inversion layer 12 made of Ni was deposited in the same manner as in Example 1. As shown in FIG. 10E, projections around the depressions pattern 13 were removed together with the inversion liftoff layer 7. In this step, the Pd protective layer 4 was exposed. The Ni inversion layer 12 deposited in the step shown in FIG. 10D and having the projections pattern remained in the region where the depressions pattern 13 existed, thereby inverting the three-dimensional shape.

FIGS. 10E, 10F, 10G, and 10H are the same steps as those shown in FIGS. 4E, 4F, 4G, and 4H, so a repetitive explanation will be omitted.

Finally, as shown in FIG. 4I, a second protective film 14 was formed by CVD (Chemical Vapor Deposition) on the Ru interlayer 2 on which the projections pattern was formed by stacking the magnetic recording layer 3 and protective layer 4, and a lubricant (not shown) was applied, thereby obtaining a patterned medium according to the embodiment.

The planar structure and sectional structure of each patterned medium manufactured by the method as described above were observed with an SEM. Consequently, dots faithfully tracing the dot structure of mesoporous silica as shown in FIG. 1 and having an inverted three-dimensional shape were periodically arranged. Table 1 below shows the ratio of the number of unisolated dots in each of Example 1, Comparative Example 1, and Examples 5 to 7.

This ratio is the result obtained by checking 1,000 dots by SEM observation. Also, in each medium having the mask liftoff layer, the number of hits, i.e., the number of times of collision between a head and the medium reduced in the evaluation of the glide characteristic measured at a floating head height of 10 nm was found. This result shows that the dot isolation improved in the media manufactured by the methods according to the embodiments.

TABLE 1

| | Ratio of unisolated dots | Number of hits |
|---|---|---|
| Example 1 | 1% | ⊚ |
| Comparative | 87% | X |
| Example 1 | | |
| Example 5 | 10% | ◯ |
| Example 6 | 1% | Δ |
| Example 7 | 2% | ⊚ |

In Table 1, the evaluation was ⊚ when the number of hits was 5 or less, ◯ when the number of hits was 10 or less, Δ when the number of hits was 20 or less, and X when the number of hits was more than 20.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium manufacturing method comprising:
forming a magnetic recording layer on a substrate;
forming an inversion liftoff layer on the magnetic recording layer;
forming a pattern formation layer on the inversion liftoff layer;
forming a depressions pattern by patterning the pattern formation layer;
transferring the depressions pattern to the inversion liftoff layer and removing the inversion liftoff layer from depressions;
forming an inversion layer on the inversion liftoff layer and the magnetic recording layer, and removing the inversion liftoff layer, thereby forming, on the magnetic recording layer, an inversion layer having a projections pattern obtained by inverting the depressions pattern; and
transferring the projections pattern to the magnetic recording layer.

2. The method according to claim 1, wherein
the forming the inversion liftoff layer on the magnetic recording layer includes forming a mask layer on the magnetic recording layer, and forming an inversion liftoff layer on the mask layer, and
after the forming the depressions pattern by patterning the pattern formation layer, and before the transferring the projections pattern to the magnetic recording layer, the method further comprises:
transferring the depressions pattern to the inversion liftoff layer, thereby exposing a surface of the mask layer to depressions;
forming an inversion layer on the inversion liftoff layer and the exposed surface of the mask layer, and removing the inversion liftoff layer, thereby forming an inversion layer having a projections pattern obtained by inverting the depressions pattern; and
transferring the projections pattern to the mask layer.

3. The method according to claim 1, wherein
the forming the inversion liftoff layer on the magnetic recording layer includes forming a liftoff layer on the magnetic recording layer, forming a mask layer on the liftoff layer, and forming an inversion liftoff layer on the mask layer, and
after the forming a depressions pattern by patterning the pattern formation layer, the method further comprises:
transferring the depressions pattern to the inversion liftoff layer, thereby exposing a surface of the mask layer to depressions;
forming an inversion layer on the inversion liftoff layer and the exposed surface of the mask layer, and removing the inversion liftoff layer, thereby forming, on the surface of the mask layer, an inversion layer having a projections pattern obtained by inverting the depressions pattern;
transferring the projections pattern to the mask layer;
transferring the projections pattern to the liftoff layer and the magnetic recording layer; and
removing the liftoff layer.

4. The method according to claim 1, wherein
the forming the inversion liftoff layer on the magnetic recording layer includes forming a liftoff layer on the magnetic recording layer, forming a mask layer on the liftoff layer, forming an inversion liftoff layer on the mask layer, and forming a sub mask layer on the inversion liftoff layer, and
after the forming the depressions pattern by patterning the pattern formation layer, the method further comprises:
transferring the depressions pattern to the sub mask layer and the inversion liftoff layer, thereby exposing a surface of the mask layer to depressions;
forming an inversion layer on the inversion liftoff layer and the exposed surface of the mask layer, and removing the inversion liftoff layer, thereby forming, on the surface of the mask layer, an inversion layer having a projections pattern obtained by inverting the depressions pattern;
transferring the projections pattern to the mask layer;
transferring the projections pattern to the liftoff layer and the magnetic recording layer; and
removing the liftoff layer.

5. The method according to claim 4, wherein the sub mask layer contains at least one material selected from the group consisting of Si-based compounds such as Si, SiO₂, and SiC, Ge-based compounds, and C-based compounds.

6. The method according to claim 1, wherein the inversion liftoff layer is selected from molybdenum, tungsten, and alloys thereof.

7. The method according to claim 1, wherein the inversion layer comprises a thin metal film selected from the group consisting of nickel, titanium, chromium, iron, and copper.

8. The method according to claim 1, wherein the pattern formation layer is formed by using a self-organizing material, and the patterning the pattern formation layer includes removing one of phases of a material phase-separated by a self-organization phenomenon.

9. The method according to claim 8, wherein the self-organizing material is selected from mesoporous silica, porous alumina, porous titania, a diblock copolymer, and a eutectic structure.

10. The method according to claim 1, wherein the pattern formation layer is formed by using a resist, and the patterning the pattern formation layer includes forming a depressions pattern by pressing a stamper having a projections pattern against the pattern formation layer, and releasing the stamper after exposure.

11. A micropattern manufacturing method comprising:
forming an inversion liftoff layer on a substrate;
forming a pattern formation layer on the inversion liftoff layer;
forming a depressions pattern by patterning the pattern formation layer;
transferring the depressions pattern to the inversion liftoff layer, and removing the inversion liftoff layer from depressions;
forming an inversion layer on the inversion liftoff layer and the substrate, and removing the inversion liftoff layer, thereby forming, on the substrate, an inversion layer having a projections pattern obtained by inverting the depressions pattern; and
transferring the projections pattern to the substrate.

12. The method according to claim 11, wherein the inversion liftoff layer is selected from molybdenum, tungsten, and alloys thereof.

13. The method according to claim 11, wherein the inversion layer comprises a thin metal film selected from the group consisting of nickel, titanium, chromium, iron, and copper.

14. The method according to claim 11, wherein the pattern formation layer is formed by using a self-organizing material, and the patterning the pattern formation layer includes removing one of phases of the material phase-separated by a self-organization phenomenon.

15. The method according to claim 14, wherein the self-organizing material is selected from mesoporous silica, porous alumina, porous titania, a diblock copolymer, and a eutectic structure.

16. The method according to claim 11, wherein the pattern formation layer is formed by using a resist, and the patterning the pattern formation layer includes forming a depressions pattern by pressing a stamper having a projections pattern against the pattern formation layer, and releasing the stamper after exposure.
